(19) United States
(12) Patent Application Publication
(10) Pub. No.: US 2025/0273894 A1
(43) Pub. Date: Aug. 28, 2025

(54) CONNECTOR

(71) Applicant: Yazaki Corporation, Tokyo (JP)

(72) Inventors: Akiyoshi TAKAGI, Shizuoka (JP); Takuro Shimada, Shizuoka (JP)

(73) Assignee: Yazaki Corporation, Tokyo (JP)

(21) Appl. No.: 19/051,722

(22) Filed: Feb. 12, 2025

(30) Foreign Application Priority Data
Feb. 26, 2024 (JP) 2024-026350

(51) Int. Cl. H01R 13/426; H01R 13/512; H01R 13/621

(52) U.S. Cl. CPC H01R 13/426; H01R 13/512; H01R 13/6215

(57) ABSTRACT

A connector includes: a housing; a terminal accommodated in the housing; and a fastening member configured to electrically connect the terminal by fastening. The housing includes insertion restrictors arranged in a vicinity of the terminal. The terminal includes protrusions configured to be in contact with the insertion restrictors at a normal arrangement position of the terminal with respect to the housing. The insertion restrictors are arranged at different positions with respect to an insertion direction of the terminal into the housing. The protrusions are arranged at different positions with respect to the insertion direction of the terminal into the housing.

### CROSS-REFERENCE TO RELATED APPLICATIONS

The present application is based on and claims the benefit of priority from the prior Japanese Patent Application No. 2024-026350, filed on Feb. 26, 2024, the entire contents of which are incorporated by reference herein.

### TECHNICAL FIELD

The disclosure relates to a connector.

### BACKGROUND

JP 2020-78971 A describes a connector including a housing, a bus bar as a terminal accommodated in the housing, and a bolt as a fastening member that electrically connects the bus bar by fastening. In this connector, an inverter is accommodated in the housing, and the bus bar is arranged in the inverter by accommodating the bus bar in the housing. The inverter and the bus bar are brought into contact with each other and electrically connected to each other by fastening the bolt.

### SUMMARY

The connector is not provided with a structure that restricts a position for inserting the terminal into the housing. For this reason, the position for arranging the terminal with respect to the housing becomes unstable, and the position for arranging the terminal may be adjusted when the fastening member is fastened, and thus the assemblability is low. In addition, erroneous assembly in which the terminal is accommodated in the opposite direction with respect to the housing may occur.

The disclosure is directed to a connector capable of improving assemblability and preventing erroneous assembly of a terminal.

A connector in accordance with some embodiments includes: a housing; a terminal accommodated in the housing; and a fastening member configured to electrically connect the terminal by fastening. The housing includes insertion restrictors arranged in a vicinity of the terminal. The terminal includes protrusions configured to be in contact with the insertion restrictors at a normal arrangement position of the terminal with respect to the housing. The insertion restrictors are arranged at different positions with respect to an insertion direction of the terminal into the housing. The protrusions are arranged at different positions with respect to the insertion direction of the terminal into the housing.

According to the above configuration, the assemblability of the connector can be improved, and erroneous assembly of the terminal in the connector can be prevented.

### BRIEF DESCRIPTION OF THE DRAWINGS

FIG. 1 is a perspective view of a connector according to a first embodiment.

FIG. 2 is an exploded perspective view of the connector according to the first embodiment.

FIG. 3 is a cross-sectional view of the connector according to the first embodiment when a second terminal is arranged at a normal position.

FIG. 4 is a cross-sectional view of the connector according to the first embodiment when the second terminal is arranged at the normal position.

FIG. 5 is a cross-sectional view of the connector according to the first embodiment when the second terminal is not arranged at the normal position.

FIG. 6 is a cross-sectional view of the connector according to the first embodiment when the second terminal is not arranged at the normal position.

FIG. 7 is a perspective view of a first housing of the connector according to the first embodiment.

FIG. 8 is an exploded perspective view of the first housing of the connector according to the first embodiment.

FIG. 9 is a perspective view of a second housing of the connector according to the first embodiment.

FIG. 10 is an exploded perspective view of the second housing of the connector according to the first embodiment.

FIG. 11 is a perspective view of a cover of the connector according to the first embodiment.

FIG. 12 is an exploded perspective view of the cover of the connector according to the first embodiment.

FIG. 13 is a cross-sectional view of a connector according to a second embodiment when a second terminal is arranged at a normal position.

FIG. 14 is a perspective view of the connector according to the second embodiment in which a part of the connector is taken as a cross section when the second terminal is accommodated in a housing.

FIG. 15 is a perspective view of the connector according to the second embodiment in which a part of the connector is taken as a cross section when the second terminal is accommodated in the housing.

FIG. 16 is a perspective view of the connector according to the second embodiment in which a part of the connector is taken as a cross section when a front holder is assembled to the housing.

### DETAILED DESCRIPTION

Hereinafter, connectors 1 and 101 according to embodiments will be described in detail with reference to the drawings. Note that dimensional ratios in the drawings are exaggerated for convenience of description, and may be different from the actual ratios.

### First Embodiment

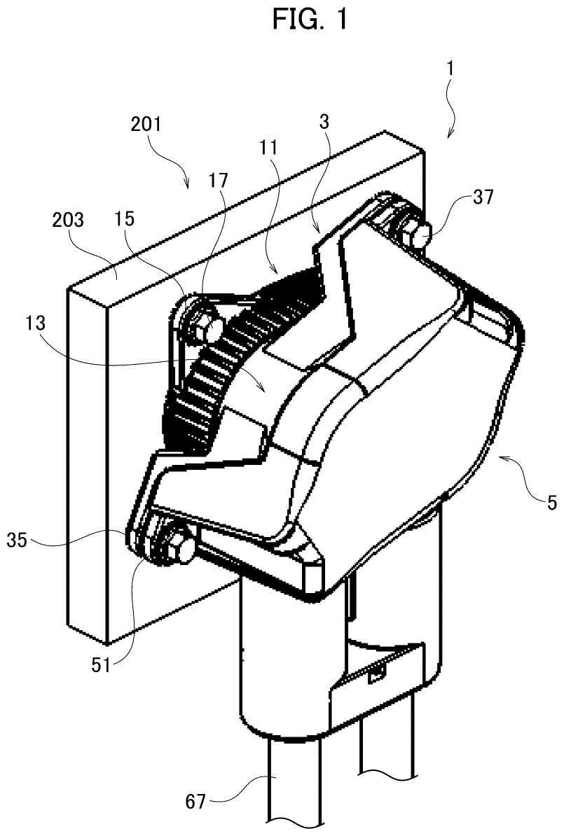

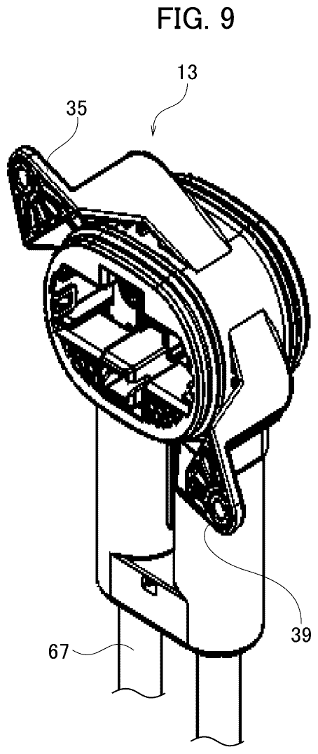

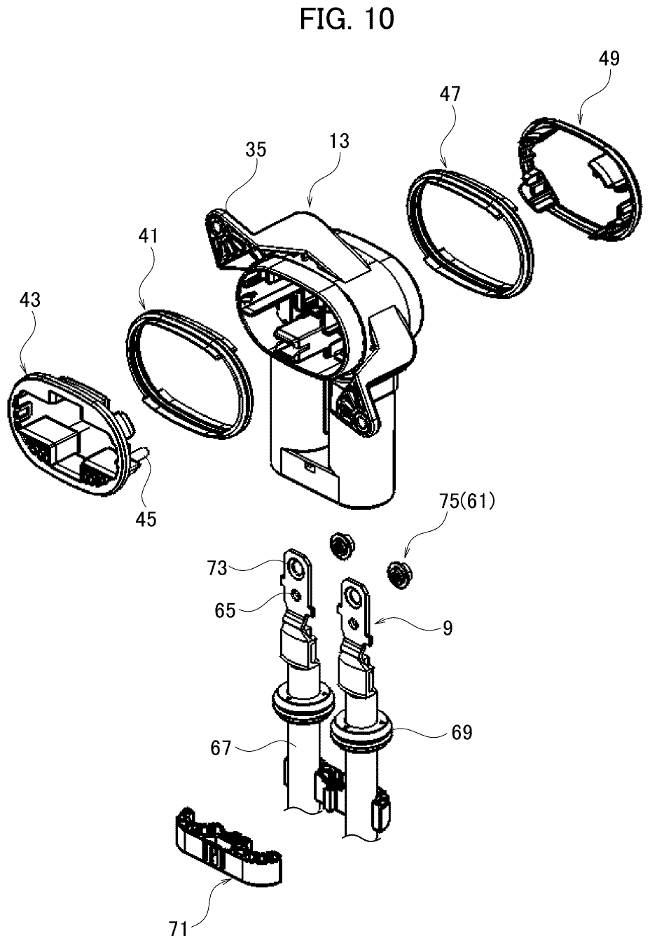

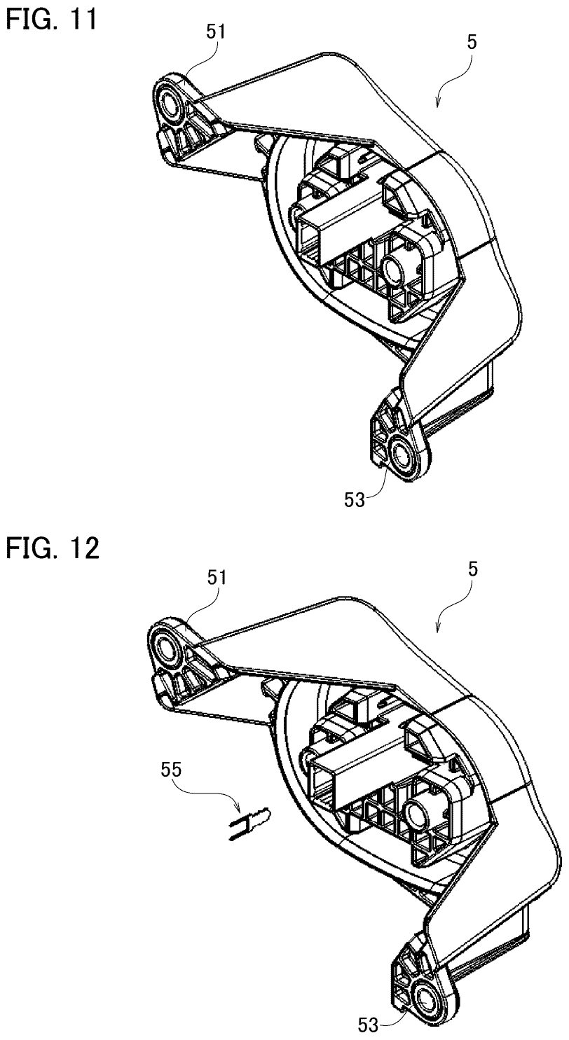

A first embodiment will be described with reference to FIGS. 1 to 12.

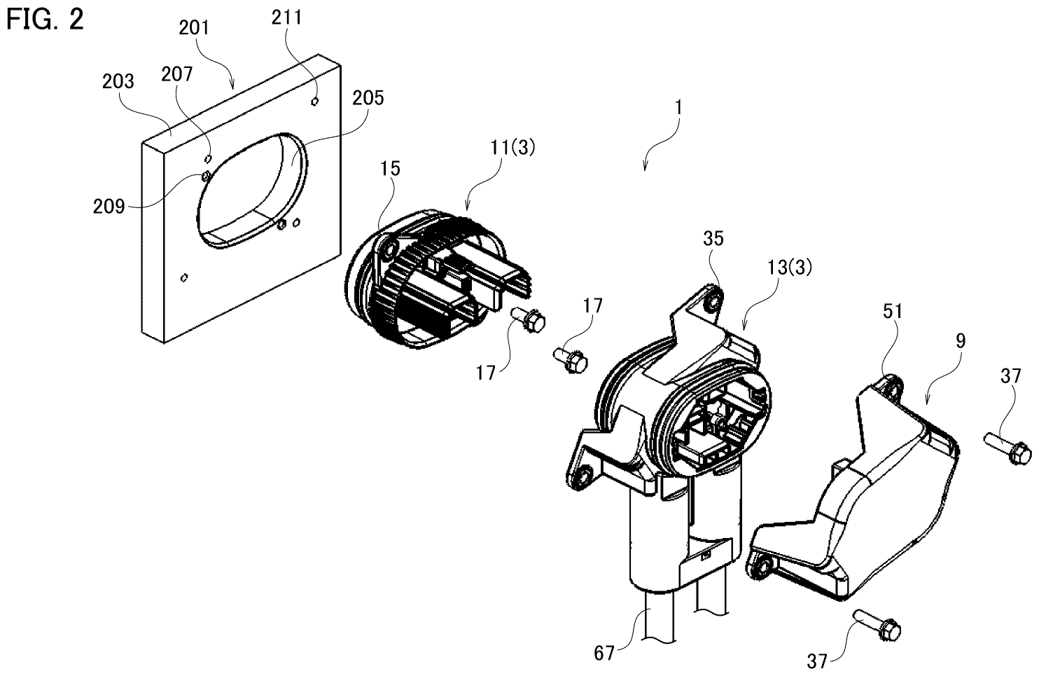

As illustrated in FIG. 1, a connector 1 according to the present embodiment is applied to, for example, an electric component 201 mounted on a vehicle. The connector 1 electrically connects, for example, the electric component 201 and other electric components (not illustrated) mounted on the vehicle, such as a power supply and a device. As illustrated in FIGS. 1 and 2, in the electric component 201, for example, a mating terminal (not illustrated) is accommodated inside a casing 203. The casing 203 is provided with an arrangement portion 205 including a through hole which is formed through a wall where the mating terminal is arranged. The connector 1 is assembled to the arrangement portion 205, and the electric component 201 and the connector 1 are electrically connected to each other.

As illustrated in FIGS. 1 to 12, the connector 1 includes a housing 3, a cover 5, a first terminal 7, and a second terminal 9 as a terminal.

As illustrated in FIGS. 1 to 10, the housing 3 includes a first housing 11 and a second housing 13.

As illustrated in FIGS. 1, 2, 7, and 8, the first housing 11 is formed of, for example, an insulating material such as a synthetic resin. The first housing 11 is formed in a tubular shape partially insertable into the arrangement portion 205 of the electric component 201. On the outer circumference of the first housing 11, a plurality of (two in the present embodiment) component fixers 15 protruding from the arrangement portion 205 of the electric component 201 to the outer diameter side are provided. A collar 19 into which a bolt 17 to be fastened to a screw hole 207 provided in the casing 203 of the electric component 201 is inserted is insert-molded in the component fixer 15. On a surface of the component fixer 15 facing the casing 203 of the electric component 201, a positioning pin 21 to be inserted into a positioning hole 209 provided in the casing 203 protrudes toward the casing 203. The component fixer 15 positions the first housing 11 with respect to the electric component 201 in a state where a part of the first housing 11 is inserted into the arrangement portion 205 of the electric component 201 by inserting the positioning pin 21 into the positioning hole 209. The component fixer 15 fixes the first housing 11 to the electric component 201 by fastening the bolt 17 to the screw hole 207 via the collar 19.

An inner housing 23 is accommodated in the first housing 11 from the electric component 201 side. The inner housing 23 is formed of, for example, an insulating material such as a synthetic resin. The inner housing 23 is held inside the first housing 11 via engaging portions (not illustrated) that engage with each other. The inner housing 23 accommodates, for example, a plurality of (two in the present embodiment) signal terminals 27 electrically connected to terminal portions of a plurality of (two in the present embodiment) signal lines 25 electrically connected to the electric component 201. A terminal holder 29 that holds the signal terminal 27 therein is assembled to the inner housing 23. Note that a locking lance that engages with the signal terminal 27 and holds the signal terminal 27 may be provided inside the inner housing 23. A packing 31 is assembled in close contact with the outer circumference of the first housing 11 on the electric component 201 side. The packing 31 is held on the first housing 11 by a front holder 33 assembled to the first housing 11 via engagement portions (not illustrated) that engage with each other. The packing 31 is in close contact with the casing 203 of the electric component 201 in a state where the first housing 11 is assembled to the electric component 201, and seals between the first housing 11 and the electric component 201. A plurality of (two in the present embodiment) the first terminals 7 are accommodated in the first housing 11 from the side opposite to the electric component 201.

As illustrated in FIGS. 1 to 6, 9, and 10, the second housing 13 is formed of, for example, an insulating material such as a synthetic resin. The second housing 13 has an upper portion formed in a tubular shape into which a part of the first housing 11 can be fitted, and a lower portion formed in a tubular shape communicating with the upper portion and extending in a direction orthogonal to the direction of fitting between the first housing 11 and the second housing 13. A plurality of (two in the present embodiment) the second terminals 9 are inserted into the lower portion of the second housing 13 from below, and the plurality of second terminals 9 are accommodated in the upper portion of the second housing 13. On the outer circumference of the upper portion of the second housing 13, a plurality of (two in the present embodiment) component fixers 35 protruding from the arrangement portion 205 of the electric component 201 to the outer diameter side are provided. A collar 39 into which a bolt 37 to be fastened to a screw hole 211 provided in the casing 203 of the electric component 201 is inserted is insert-molded in the component fixer 35. The component fixer 35 fixes the second housing 13 to the electric component 201 by fastening the bolt 37 to the screw hole 211 via the collar 39 in a state where the first housing 11 and the second housing 13 are fitted to each other. Note that the first housing 11 and the second housing 13 may be provided with engagement portions that engage with each other to hold the fitted state between the first housing 11 and the second housing 13.

A front packing 41 is assembled in close contact with the upper portion of the second housing 13 on the first housing 11 side. The front packing 41 is held on the second housing 13 by a front holder 43 as a holder assembled to the second housing 13 via engaging portions (not illustrated) that engage with each other. In the front holder 43, a plurality of (two in the present embodiment) holding pins 45 protrude toward the second terminal 9 accommodated in the second housing 13. The front packing 41 is in close contact with the first housing 11 in a state where the first housing 11 and the second housing 13 are fitted to each other, and seals between the first housing 11 and the second housing 13. A rear packing 47 is assembled in close contact with the upper portion of the second housing 13 on the cover 5 side. The rear packing 47 is held on the second housing 13 by a rear holder 49 assembled to the second housing 13 via engagement portions (not illustrated) that engage with each other. The rear packing 47 is in close contact with the cover 5 in a state where the second housing 13 is covered with the cover 5, and seals between the second housing 13 and the cover 5.

As illustrated in FIGS. 1, 2, 11, and 12, the cover 5 is formed of, for example, an insulating material such as a synthetic resin. The cover 5 covers the outer circumference of the upper portion of the second housing 13 on the side opposite to the electric component 201, and is formed in a shape capable of closing the opening of the second housing 13. On the outer circumference of the cover 5, a plurality of (two in the present embodiment) component fixers 51 protruding from the arrangement portion 205 of the electric component 201 to the outer diameter side is provided at the same positions as the component fixers 35 of the second housing 13. A collar 53 into which a bolt 37 to be fastened to a screw hole 211 provided in the casing 203 of the electric component 201 is inserted is insert-molded in the component fixer 51. The component fixer 51 fixes the cover 5 to the electric component 201 by fastening the bolt 37 to the screw hole 211 via the collar 53 in a state where the cover 5 covers the second housing 13. By providing the component fixers 51 at the same positions as the component fixers 35 of the second housing 13, the cover 5 can be fixed by the same bolt 37, and the number of components can be reduced. Note that the second housing 13 and the cover 5 may be provided with engagement portions that engage with each other to hold a state where the cover 5 covers the second housing 13. The cover 5 accommodates a short terminal 55 that electrically connects a plurality of (two in the present embodiment) the signal terminals 27 accommodated in the first housing 11, for example, by press fitting or the like. When the cover 5 is assembled to the electric component 201, the short terminal 55 electrically connects the plurality of signal terminals 27, and detects that the cover 5 is normally assembled to the electric component 201.

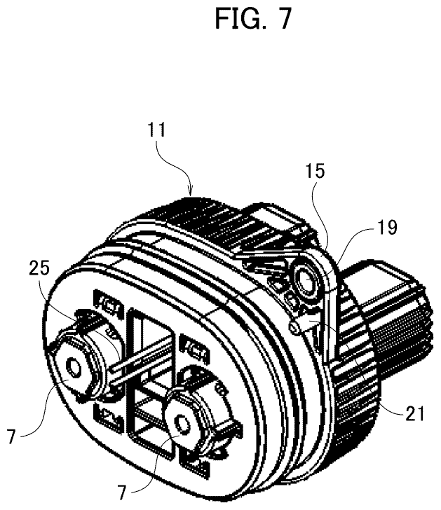

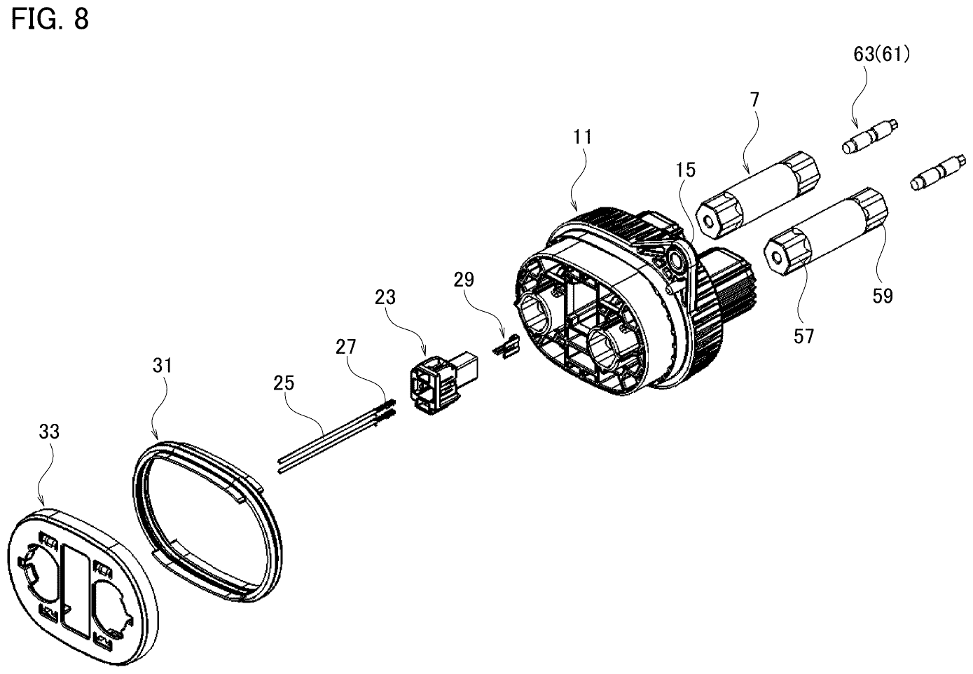

As illustrated in FIGS. 7 and 8, the first terminal 7 is formed of a conductive material, and is formed, for example, in a columnar shape. The plurality of (two in the present embodiment) the first terminals 7 are accommodated in the first housing 11. The arrangement position of the first terminals 7 with respect to the first housing 11 is held, for example, by press fitting. Mating connectors 57 and terminal connectors 59 each formed by screw holes are provided on both end sides of the first terminals 7. For example, a mating screw member (not illustrated) formed of a stud bolt is fastened to the mating connector 57, and is integrally fixed with the first terminal 7. The mating terminal of the electric component 201 is arranged on the mating screw member, and a mating nut (not illustrated) is fastened to the mating screw member. By fastening the mating nut to the mating screw member, the mating terminal and the first terminal 7 come into contact with each other, and the mating terminal and the first terminal 7 are electrically connected to each other.

For example, a screw member 63 as a fastening member 61 formed of a stud bolt is fastened to the terminal connector 59, and the screw member 63 is integrally fixed to the first terminal 7. By fixing the screw member 63 to the first terminal 7, the screw member 63 can be handled as one member with the first terminal 7, and the number of components can be reduced, whereby management and handling can be simplified. Note that the screw member 63 may be formed into one member continuous with the first terminal 7, for example, by forming the end portion of the first terminal 7 on the terminal connector 59 side in a columnar shape, and forming the outer circumference of the columnar portion in a screw shape. The second terminal 9 is arranged on the screw member 63.

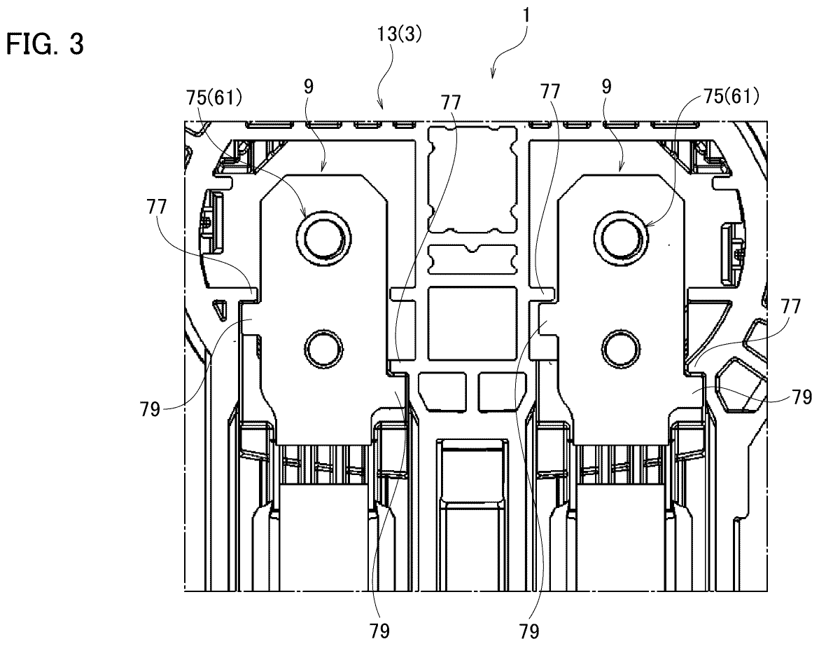

As illustrated in FIGS. 3 to 6, 9, and 10, the second terminal 9 is formed of a conductive material, and is formed, for example, in a plate shape. The plurality of (two in the present embodiment) second terminals 9 are accommodated in the second housing 13. In the second terminal 9, a pin hole 65 into which the holding pin 45 of the front holder 43 is inserted is provided through the second terminal 9. By inserting the holding pin 45 into the pin hole 65, the second terminal 9 is held at a normal arrangement position with respect to the second housing 13. The plurality of second terminals 9 are electrically connected to, for example, terminal portions of a plurality of (two in the present embodiment) cables 67 electrically connected to other electric components (not illustrated) by crimping, welding, or the like. A rubber plug 69 is assembled in close contact with the outer circumference of the cable 67 on the second terminal 9 side. The rubber plug 69 is held to the second housing 13 by a lower holder 71 assembled to the second housing 13 via engagement portions (not illustrated) that engage with each other. The lower holder 71 is divided into two and assembled to the cable 67 via engaging portions (not illustrated) that engage with each other. By dividing the lower holder 71, the assembly position on the cable 67 can be freely determined, and the assemblability can be improved. The rubber plug 69 is in close contact with the second housing 13 in a state where the second terminal 9 is accommodated in the second housing 13, and seals between the second housing 13 and the cable 67.

The second terminal 9 is provided with an arrangement hole 73 formed through the second terminal 9 at a position corresponding to the screw member 63 of the first terminal 7 in a state where the first housing 11 and the second housing 13 are fitted to each other. A nut 75 is arranged in the arrangement hole 73 as the fastening member 61, and the nut 75 is rotatably and integrally assembled with the second terminal 9 by, for example, caulking or the like. By rotatably and integrally assembling the nut 75 with the second terminal 9, the nut 75 can be handled as one member with the second terminal 9, and the number of components can be reduced, whereby management and handling can be simplified. By rotatably assembling the nut 75 to the second terminal 9, the nut 75 can be fastened to the screw member 63 even when the screw member 63 is integrally provided with the first terminal 7. The nut 75 is arranged with a gap between the nut 75 and the outer surface of the second terminal 9, and can be inclined in a direction intersecting the axis of the screw member 63. Therefore, when the second terminal 9 is arranged in an inclined manner, the nut 75 is inclined, so that the axis of the screw member 63 and the axis of the nut 75 can be arranged substantially on the same line, and the nut 75 can be stably fastened to the screw member 63.

In the fastening member 61 including the screw member 63 and the nut 75, the nut 75 is arranged at the end of the screw member 63 in a state where the first housing 11 and the second housing 13 are fitted to each other. At this time, when the screw member 63 and the nut 75 are in contact with each other, and the second terminal 9 is inclined in the direction intersecting the axis of the screw member 63, the nut 75 is inclined in the direction intersecting the axis of the screw member 63. Due to the inclination of the nut 75, the axis of the screw member 63 and the axis of the nut 75 are arranged substantially on the same line, and the inclination of the second terminal 9 can be absorbed. By fastening the nut 75 to the screw member 63 in a state where the nut 75 is arranged on the screw member 63, the first terminal 7 and the second terminal 9 come into contact with each other, and the first terminal 7 and the second terminal 9 are electrically connected to each other.

Here, in a case where the second terminal 9 is inserted too far into the second housing 13 or in a case where the second terminal 9 is not sufficiently inserted into the second housing 13, the screw member 63 and the nut 75 as the fastening member 61 are not aligned, and the first terminal 7 and the second terminal 9 cannot be electrically connected to each other. In addition, there is a possibility that erroneous assembly in which the second terminal 9 is accommodated in the opposite direction with respect to the second housing 13 occurs. Therefore, the second housing 13 and the second terminal 9 are provided with an insertion restrictor 77 and a protrusion 79 for arranging the second terminal 9 at a normal position in the second housing 13.

A plurality of (two in the present embodiment) the insertion restrictors 77 are provided inside the second housing 13 so as to be positioned on both sides of the second terminal 9 in the width direction. Each of the plurality of insertion restrictors 77 extends toward the side surface of the second terminal 9. The plurality of insertion restrictors 77 are arranged at different positions with respect to the insertion direction of the second terminal 9 into the second housing 13.

A plurality of (two in the present embodiment) the protrusions 79 are provided so as to protrude outward in the width direction from the side surfaces of the second terminal 9 on both sides in the width direction. Similarly to the plurality of insertion restrictors 77, the plurality of protrusions 79 are arranged at different positions with respect to the insertion direction of the second terminal 9 into the second housing 13.

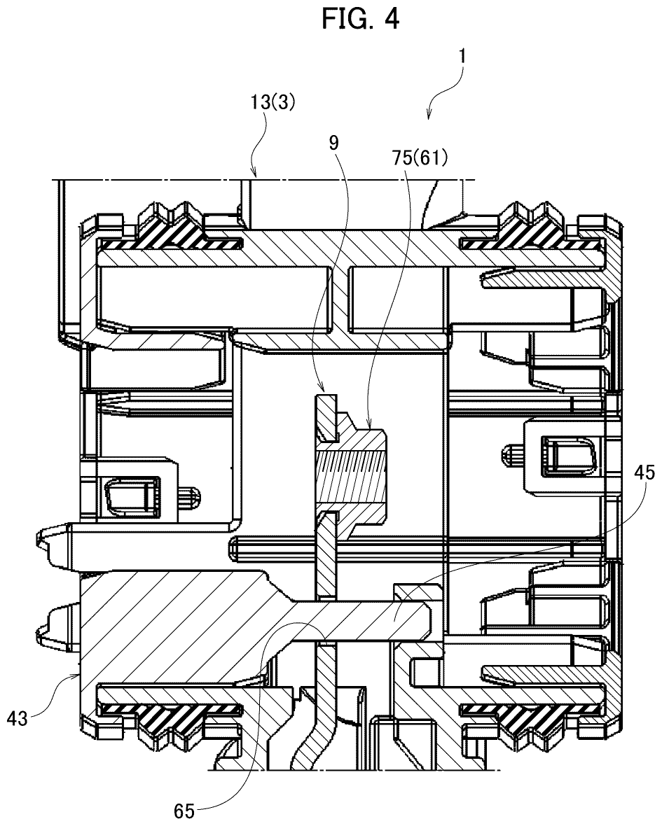

As illustrated in FIG. 3, when the second terminal 9 is inserted into the second housing 13 in the normal direction, the second terminal 9 can be inserted into the second housing 13 until each of the plurality of protrusions 79 comes into contact with each of the plurality of insertion restrictors 77. In a state where each of the plurality of protrusions 79 is in contact with each of the plurality of insertion restrictors 77, the second terminal 9 is accommodated at a normal arrangement position in the second housing 13. Therefore, the fastening member 61 can be fastened without adjusting the arrangement position of the second terminal 9, and the assemblability can be improved. In a state where each of the plurality of protrusions 79 is in contact with each of the plurality of insertion restrictors 77, the holding pin 45 of the front holder 43 can be inserted into the pin hole 65 of the second terminal 9, as illustrated in FIG. 4. Therefore, the front holder 43 can be assembled to the second housing 13, and it is possible to detect that the second terminal 9 is arranged at a normal position.

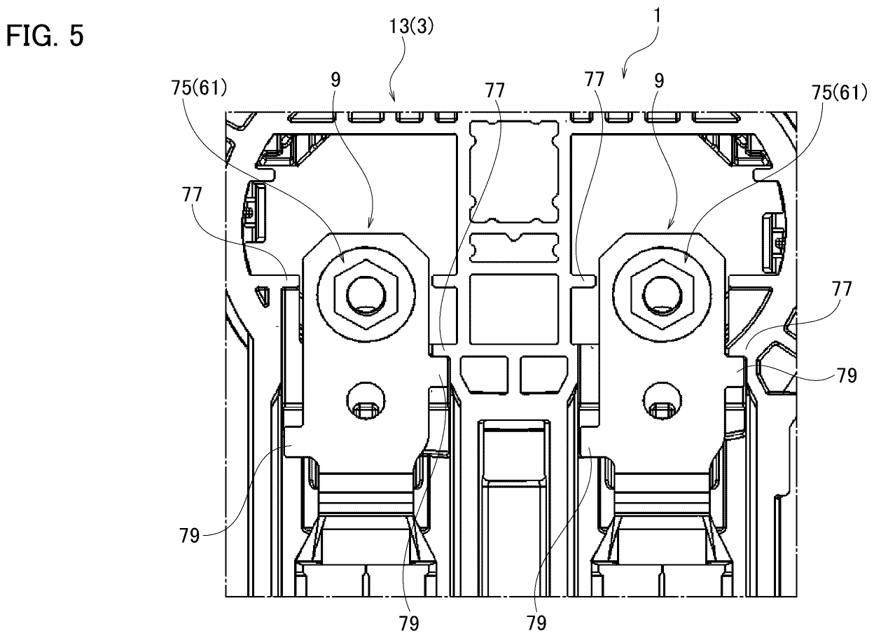

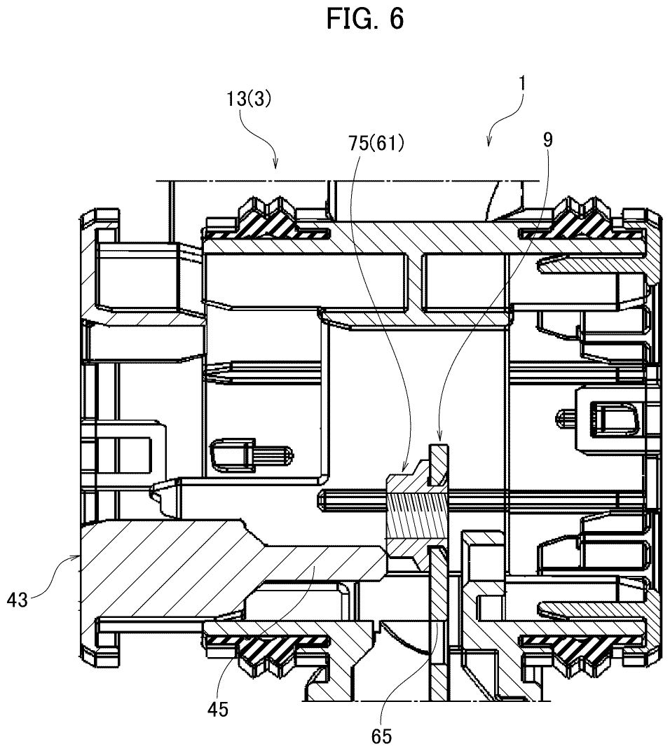

As illustrated in FIG. 5, when the second terminal 9 is inserted into the second housing 13 in the opposite direction, the protrusion 79 located on the front side in the insertion direction comes into contact with the insertion restrictor 77 located on the rear side in the insertion direction. In a state where the protrusion 79 located on the front side in the insertion direction is in contact with the insertion restrictor 77 located on the rear side in the insertion direction, the second terminal 9 is not accommodated at the normal arrangement position in the second housing 13. Therefore, the fastening member 61 cannot be fastened, and it is possible to detect that the erroneous assembly in the second terminal 9 has occurred. In a state where the protrusion 79 located on the front side in the insertion direction is in contact with the insertion restrictor 77 located on the rear side in the insertion direction, the holding pin 45 of the front holder 43 cannot be inserted into the pin hole 65 of the second terminal 9, as illustrated in FIG. 6. Therefore, the front holder 43 cannot be assembled to the second housing 13, and it is possible to detect that the erroneous assembly to the second terminal 9 has occurred.

As an example of such assembly of the connector 1, first, the first housing 11, the second housing 13, and the cover 5 are each assembled.

In the assembling of the first housing 11, first, the signal terminal 27 provided at the terminal portion of the signal line 25 is accommodated in the inner housing 23, and the terminal holder 29 is assembled. Next, the inner housing 23 and the first terminal 7 are accommodated in the first housing 11. Next, the screw member 63 is fastened to the first terminal 7. The first terminal 7 to which the screw member 63 is fastened in advance may be accommodated in the first housing 11. Then, the packing 31 is mounted on the first housing 11, and the front holder 33 is assembled, thus completing the assembly of the first housing 11.

In the assembling of the second housing 13, first, the nut 75 is assembled to the second terminal 9, and the second terminal 9 is assembled to the end portion of the cable 67 on which the rubber plug 69 is mounted. Next, the second terminal 9 is accommodated in the second housing 13, and the lower holder 71 is assembled. At this time, when the second terminal 9 is in the normal direction, each of the plurality of protrusions 79 is in contact with each of the plurality of insertion restrictors 77, and the second terminal 9 is accommodated at the normal position in the second housing 13. On the other hand, when the second terminal 9 is in the opposite direction, the protrusions 79 on the front side in the insertion direction is in contact with the insertion restrictors 77 on the rear side in the insertion direction, and the second terminal 9 is not accommodated at the normal position in the second housing 13. Then, the front packing 41 and the rear packing 47 are mounted on the second housing 13, and the front holder 43 and the rear holder 49 are assembled, thus completing the assembly of the second housing 13. At this time, when the second terminal 9 is arranged at a normal position, the holding pin 45 is inserted into the pin hole 65, and the front holder 43 can be assembled to the second housing 13. On the other hand, when the second terminal 9 is not arranged at the normal position, the holding pin 45 cannot be inserted into the pin hole 65, and the front holder 43 cannot be assembled to the second housing 13.

In the assembly of the cover 5, the short terminal 55 is assembled to the cover 5, and the assembly of the cover 5 is completed.

In the assembling of the connector 1, first, the first housing 11 is arranged in the arrangement portion 205 of the electric component 201 so that the positioning pin 21 is inserted into the positioning hole 209. Next, the bolt 17 is inserted into the collar 19 of the component fixer 15 of the first housing 11, the bolt 17 is fastened to the screw hole 207, and the first housing 11 is assembled to the electric component 201. Next, the second housing 13 is arranged so that the first housing 11 is fitted inside the upper portion of the second housing 13. Next, the nut 75 is fastened to the screw member 63 to electrically connect the first terminal 7 and the second terminal 9. Next, the cover 5 is assembled to the second housing 13. Then, the bolt 37 is inserted into the collar 39 of the component fixer 35 of the second housing 13 and the collar 53 of the component fixer 51 of the cover 5, and the bolt 37 is fastened to the screw hole 211 to complete the assembly of the connector 1.

Such a connector 1 includes the housing 3, the second terminal 9 as a terminal accommodated in the housing 3, and the fastening member 61 that electrically connects the second terminal 9 by fastening. The housing 3 is provided with insertion restrictors 77 arranged in the vicinity of the second terminal 9. The second terminal 9 is provided with protrusions 79 that are in contact with the insertion restrictors 77 at a normal arrangement position of the second terminal 9 with respect to the housing 3. A plurality of the insertion restrictors 77 are provided so that the insertion restrictors 77 are arranged at different positions with respect to the insertion direction of the second terminal 9 into the housing 3. A plurality of the protrusions 79 are provided so that the protrusions 79 are arranged at different positions with respect to the insertion direction of the second terminal 9 into the housing 3.

When the second terminal 9 is inserted into the second housing 13 in the normal direction, the second terminal 9 can be inserted into the second housing 13 until each of the plurality of protrusions 79 comes into contact with each of the plurality of insertion restrictors 77. In a state where each of the plurality of protrusions 79 is in contact with each of the plurality of insertion restrictors 77, the second terminal 9 is accommodated at a normal arrangement position in the second housing 13. Therefore, the fastening member 61 can be fastened without adjusting the arrangement position of the second terminal 9, and the assemblability can be improved. On the other hand, when the second terminal 9 is inserted into the second housing 13 in the opposite direction, the protrusions 79 located on the front side in the insertion direction comes into contact with the insertion restrictors 77 located on the rear side in the insertion direction. In a state where the protrusion 79 located on the front side in the insertion direction is in contact with the insertion restrictor 77 located on the rear side in the insertion direction, the second terminal 9 is not accommodated at the normal arrangement position in the second housing 13. Therefore, the fastening member 61 cannot be fastened, and it is possible to detect that the erroneous assembly in the second terminal 9 has occurred.

Therefore, in such a connector 1, assemblability can be improved, and the erroneous assembly of the second terminal 9 can be prevented.

The front holder 43 as a holder for holding the second terminal 9 in the housing 3 is assembled to the housing 3. The second terminal is provided with the pin hole 65. The front holder 43 is provided with the holding pin 45 to be inserted into the pin hole 65 at a normal arrangement position of the second terminal 9 with respect to the housing 3.

When the second terminal 9 is arranged at a normal position, the holding pin 45 of the front holder 43 can be inserted into the pin hole 65 of the second terminal 9. Therefore, the front holder 43 can be assembled to the housing 3, and it is possible to detect that the second terminal 9 is arranged at a normal position. On the other hand, when the second terminal 9 is not arranged at a normal position, the holding pin 45 of the front holder 43 cannot be inserted into the pin hole 65 of the second terminal 9. Therefore, the front holder 43 cannot be assembled to the housing 3, and it is possible to detect that the erroneous assembly in the second terminal 9 has occurred.

### Second Embodiment

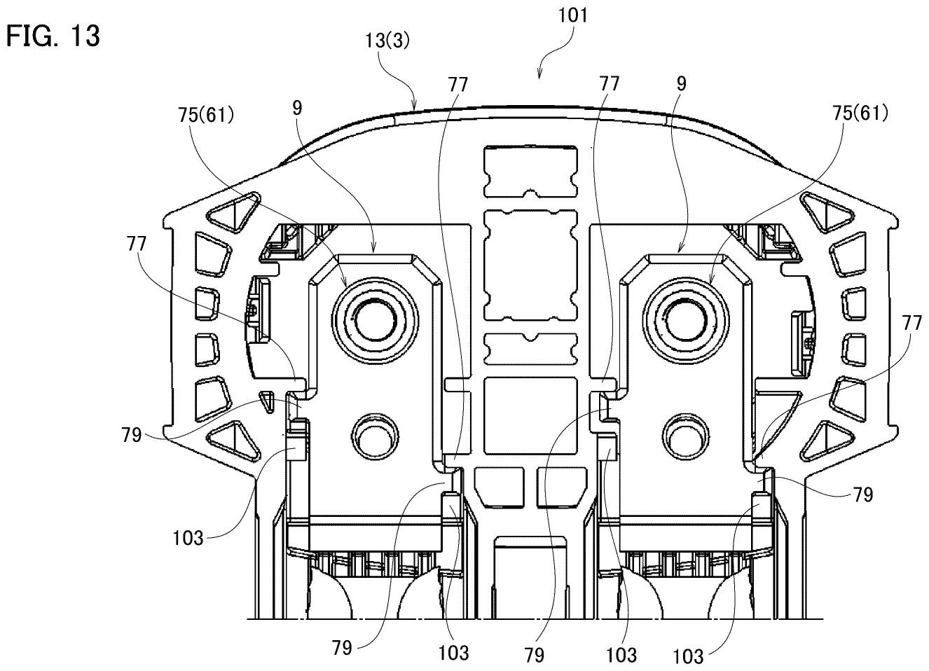

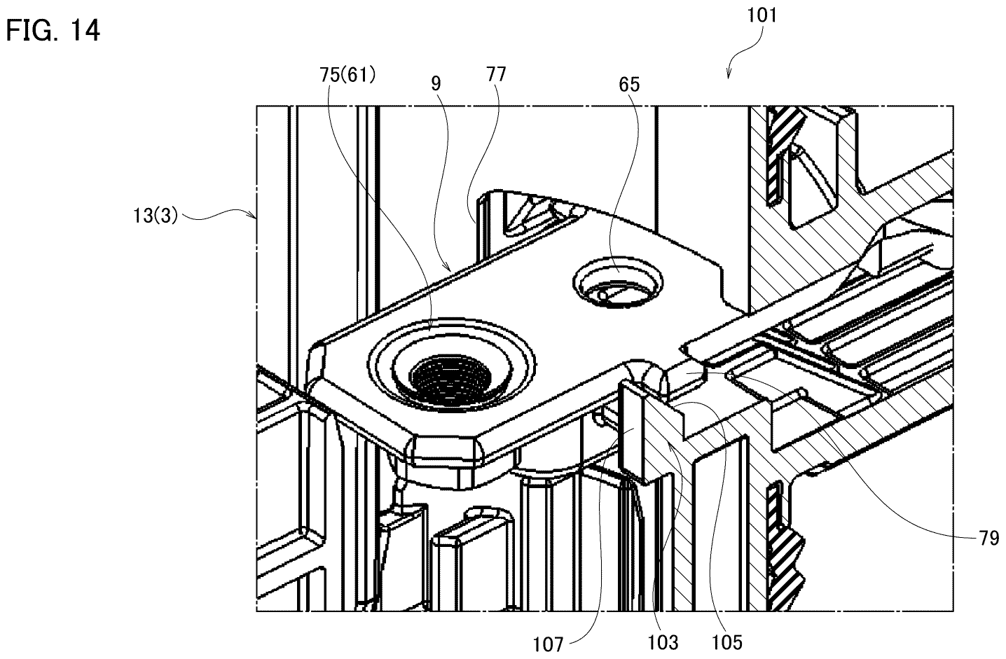

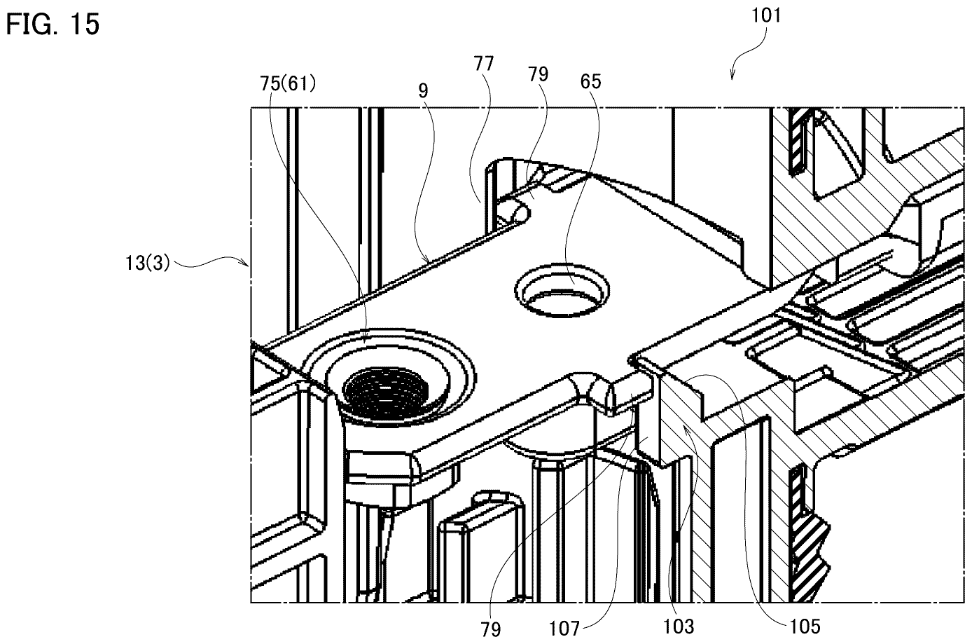

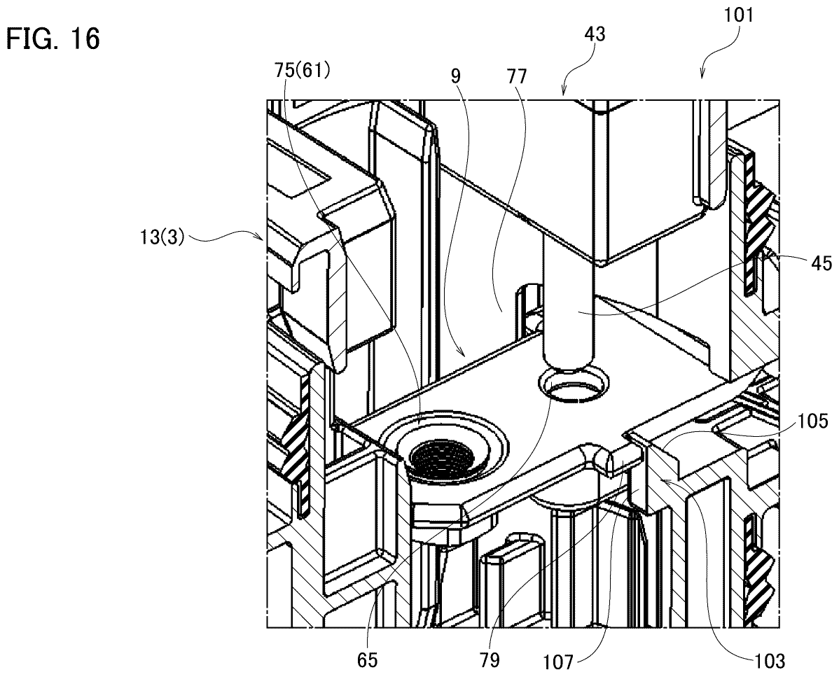

A second embodiment will be described with reference to FIGS. 13 to 16.

In a connector 101 according to the present embodiment, a housing 3 is provided with a detachment restrictor 103 that can be engaged with a protrusion 79 in the detachment direction of a second terminal 9 from the housing 3 at a normal arrangement position of the second terminal 9 with respect to the housing 3.

Note that the same configurations as those in the first embodiment will be denoted by the same symbols, and the description of the functions will be omitted as the first embodiment can be referred to regarding the functions. Since the configurations are similar, the obtained actions and effects are equivalent.

As illustrated in FIGS. 13 to 16, a second housing 13 as the housing 3 is provided with the detachment restrictor 103. A plurality of (two in the present embodiment) the detachment restrictors 103 are provided inside the second housing 13 so as to be positioned on both sides of the second terminal 9 in the width direction. The plurality of detachment restrictors 103 are arranged apart from the plurality of insertion restrictors 77 so as to have gaps between the detachment restrictors 103 and the insertion restrictors 77 in which the protrusions 79 can be arranged, at positions corresponding to the insertion restrictors 77. The detachment restrictor 103 protrudes in a direction orthogonal to the insertion direction of the second terminal 9. In the detachment restrictor 103, an inclined surface 105 inclined upward toward the front side in the insertion direction is formed on the rear side in the insertion direction of the second terminal 9 into the second housing 13. In the detachment restrictor 103, a locking surface 107 serving as a vertical surface perpendicular to the insertion direction is formed on the front side in the insertion direction of the second terminal 9 into the second housing 13.

When the second terminal 9 is inserted into the second housing 13, the inclined surface 105 of the detachment restrictor 103 slides on the protrusion 79, and the second terminal 9 is moved so as to surmount the detachment restrictor 103. The second terminal 9 that has surmounted the detachment restrictor 103 is arranged at a normal position in the second housing 13, and the protrusion 79 is arranged so as to be engageable with the locking surface 107 of the detachment restrictor 103. When the protrusion 79 engages with the locking surface 107, detachment of the second terminal 9 from the second housing 13 is prevented, and the second terminal 9 can be held at a normal arrangement position in the second housing 13. Therefore, the fastening member 61 can be stably fastened, and electrical connection reliability can be maintained. The second terminal 9 can be held at a normal arrangement position in the second housing 13 even when the holding pin 45 of the front holder 43 is not inserted into the pin hole 65 of the second terminal 9. Therefore, when the second terminal 9 cannot be detached from the second housing 13, it is possible to detect that the second terminal 9 is arranged at a normal position. By the engagement between the protrusion 79 and the detachment restrictor 103, for example, the holding pin 45 can be inserted into the pin hole 65 without involving the operation of the operator holding the second terminal 9, and the assemblability of the front holder 43 to the second housing 13 can be improved.

In such a connector 101, the housing 3 is provided with the detachment restrictor 103 that is engageable with the protrusion 79 in the detachment direction of the second terminal 9 from the housing 3 at a normal arrangement position of the second terminal 9 with respect to the housing 3.

The engagement between the protrusion 79 and the detachment restrictor 103 allows the second terminal 9 to be held at a normal arrangement position in the housing 3. Therefore, the fastening member 61 can be stably fastened, and electrical connection reliability can be maintained. When the second terminal 9 cannot be detached from the housing 3, it is possible to detect that the second terminal 9 is arranged at a normal position.

In the above embodiment, the screw member 63 is provided integrally with the first terminal 7, and the nut 75 is rotatably and integrally assembled with the second terminal 9, but the present invention is not limited thereto. For example, the screw member 63 may be provided integrally with the second terminal 9, and the nut 75 may be rotatably and integrally assembled with the first terminal 7. Alternatively, the nut 75 may be integrally provided on one of the first terminal 7 and the second terminal 9, and the screw member 63 may be rotatably and integrally assembled with the other terminal. The fastening member 61 includes the screw member 63 and the nut 75, but is not limited thereto, and the fastening member 61 may only include the screw member 63.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector comprising:
a housing;
a terminal accommodated in the housing; and
a fastening member configured to electrically connect the terminal by fastening,
wherein the housing includes insertion restrictors arranged in a vicinity of the terminal,
the terminal includes protrusions configured to be in contact with the insertion restrictors at a normal arrangement position of the terminal with respect to the housing,
the insertion restrictors are arranged at different positions with respect to an insertion direction of the terminal into the housing, and
the protrusions are arranged at different positions with respect to the insertion direction of the terminal into the housing.

2. The connector according to claim 1, further comprising: a holder assembled to the housing and configured to hold the terminal in the housing, wherein
the terminal includes a pin hole, and
the holder includes a holding pin inserted into the pin hole at the normal arrangement position of the terminal with respect to the housing.

3. The connector according to claim 1, wherein the housing includes a detachment restrictor engageable with one of the protrusions in a detachment direction of the terminal from the housing at the normal arrangement position of the terminal with respect to the housing.

4. The connector according to claim 2, wherein the housing includes a detachment restrictor engageable with one of the protrusions in a detachment direction of the terminal from the housing at the normal arrangement position of the terminal with respect to the housing.
